(19) United States
(12) Patent Application Publication
(10) Pub. No.: US 2008/0218563 A1
(43) Pub. Date: Sep. 11, 2008

(54) TUBE PUMP FOR FLUID EJECTING APPARATUS, FLUID EJECTING APPARATUS, AND METHOD FOR ADJUSTING FLUID-VACUUMING CAPABILITY OF PUMP

(75) Inventor: Hideki OKUMURA, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/042,817

(22) Filed: Mar. 5, 2008

(30) Foreign Application Priority Data
Mar. 6, 2007 (JP) 2007-055183
Mar. 6, 2007 (JP) 2007-055184
Dec. 28, 2007 (JP) 2007-338583

(51) Int. Cl. B41J 2/17

(52) U.S. Cl. 347/84

(57) ABSTRACT

A tube pump for a fluid ejecting apparatus, the tube pump vacuuming fluid through a cap member from a fluid ejecting head for ejecting fluid, includes a specific-vacuuming-capability-information storage unit for storing specific-vacuuming-capability information that indicates a vacuuming capability specific to the tube pump.

### BACKGROUND

1. Technical Field

The present invention relates to a tube pump for a fluid ejecting apparatus for ejecting fluid onto an object, a fluid ejecting apparatus, and a method for adjusting the fluid-vacuuming capability of a pump.

2. Related Art

Ink jet recording apparatuses, for example, have an ink jet recording head for ejecting ink onto an object such as recording paper. Because ink jet recording heads eject ink onto recording paper through nozzles, thickened ink near nozzles or air bubbles in nozzles may prevent proper ejection of ink.

Therefore, ink jet recording apparatuses have a head cleaning unit to avoid the above-described situations.

A head cleaning unit includes a capping member disposed so as to cover nozzles, and a pump for creating a negative pressure in the capping member. A head cleaning unit cleans an ink jet recording head by vacuuming ink near nozzles with the pump.

An example of the pump is a tube pump, which has a relatively simple structure and which can easily be made compact.

A tube pump includes a hollow tube disposed in the form of a loop, and a roller capable of movement so as to press the tube. Movement of the roller causes the tube pump to vacuum ink in a capping member. The vacuumed ink is stored in a waste fluid tank as waste ink.

The pump efficiency of tube pumps having the above-described structure is degraded with long-term use of the tube pumps. JP-A-2003-39709 (FIG. 4, etc.), for example, proposes a mechanism for compensating for loss of pump efficiency.

Variation in pump efficiency of tube pumps is created not only with long-term use of the tube pumps, but also in the manufacturing process of the tube pumps. Because of dimensional variation of components and assembly variation occurred in the manufacturing process, finished tube pumps inevitably have different vacuuming capabilities, i.e., individual differences. In particular, in tube pumps, the dimensional accuracy of the tube pumps and the hardness of the tubes tend to vary.

This has lead to problems in that, because apparatuses using such pumps have different ink-vacuuming capabilities, the apparatuses fail to perform proper cleaning and the apparatuses consume unnecessarily large amounts of ink.

Further, because waste ink is sent to a waste ink tank through a tube pump, the amount of waste ink sent to the waste ink tank may exceed the capacity of the waste ink tank. Thus, it is necessary to accurately determine the amount of ink vacuumed by a tube pump. However, tube pumps vacuum different amount of ink because of assembly variation. Therefore, it has been difficult to accurately determine the amount of ink vacuumed by a tube pump.

### SUMMARY

An advantage of some aspects of the invention is that it provides tube pumps whose individual differences in vacuuming capability derived from assembly in the manufacturing process are made easily recognizable, fluid ejecting apparatuses capable of efficiently correcting the individual differences in vacuuming capability of the tube pumps and accurately managing the amount of fluid vacuumed by the tube pumps, and a method for adjusting the fluid-vacuuming capability of a pump.

According to a first aspect of the invention, a tube pump for a fluid ejecting apparatus, the tube pump vacuuming fluid through a cap member from a fluid ejecting head for ejecting fluid, includes a specific-vacuuming-capability-information storage unit for storing specific-vacuuming-capability information that indicates a vacuuming capability specific to the tube pump.

In this structure, the fluid ejecting apparatus includes the specific-vacuuming-capability-information storage unit for storing the specific-vacuuming-capability information that indicates the vacuuming capability specific to the tube pump. Therefore, by referring to the specific-vacuuming-capability information, individual differences between tube pumps due to assembly variation occurred in the manufacturing process can be easily recognized.

It is preferable that the specific-vacuuming-capability information include information about a flow rate or flow velocity of fluid in the tube pump for a certain period of time.

In this structure, the specific-vacuuming-capability information includes the information about the flow rate or flow velocity of the fluid in the tube pump for a certain period of time.

Therefore, because the fluid ejecting apparatus has the information about the flow rate or flow velocity, which is necessary for vacuuming fluid, as information about individual differences between tube pumps, the fluid ejecting apparatus can easily recognize the individual differences between tube pumps.

It is preferable that the specific-vacuuming-capability information include information about a load applied to a motor for driving the tube pump when the motor drives the tube pump.

In this structure, the specific-vacuuming-capability information includes the information about a load applied to the motor for driving the tube pump when the motor drives the tube pump.

Therefore, because the information about the individual differences between tube pumps is indicated by the information about a load applied to the motor, it becomes possible to choose a motor for driving a tube pump according to the load.

It is preferable that the specific-vacuuming-capability information includes code information.

In this structure, because the specific-vacuuming-capability information includes the code information, handling of the specific-vacuuming-capability information is easy.

It is preferable that the specific-vacuuming-capability-information storage unit is disposed in the tube pump.

In this structure, because the specific-vacuuming-capability-information storage unit is disposed in the tube pump, even when the tube pump is replaced with a new tube pump, the specific-vacuuming-capability information of the new pump can be easily acquired.

Therefore, even when the tube pump is replaced with a new tube pump, correction taking the assembly variation of the new tube pump into consideration can be performed.

According to a second aspect of the invention, a fluid ejecting apparatus includes a fluid ejecting head for ejecting fluid, and the tube pump according to the first aspect of the invention.

It is preferable that the fluid ejecting apparatus further include a correction-information storage unit for storing correction information used to correct the specific vacuuming capability of the tube pump according to the specific-vacuuming-capability information, and a specific-vacuuming-capability correcting section for correcting the specific vacuuming capability of the tube pump according to the correction information.

In this structure, the fluid ejecting apparatus further includes the correction-information storage unit for storing the correction information used to correct the specific vacuuming capability of the tube pump according to the specific-vacuuming-capability information, and the specific-vacuuming-capability correcting section for correcting the specific vacuuming capability of the tube pump according to the correction information.

Because the specific-vacuuming-capability correcting section corrects the specific vacuuming capability of the tube pump by referring to the correction information according to the specific-vacuuming-capability information, assembly variation or the like occurred in the manufacturing process of tube pumps can be reduced. Accordingly, a fluid ejecting apparatus having a tube pump capable of vacuuming a proper amount of fluid can be provided.

It is preferable that the fluid ejecting apparatus specify a vacuum flow rate of the tube pump according to the specific-vacuuming-capability information, and calculate the amount of fluid vacuumed by the tube pump, using the specified vacuum flow rate.

Therefore, even if the fluid-vacuuming capabilities of tube pumps vary, the amount of fluid vacuumed by a tube pump can be accurately determined by specifying the vacuum flow rate of the tube pump according to the specific-vacuuming-capability information, and by multiplying the specified vacuum flow rate by the rotational frequency of the tube pump.

According to a third aspect of the invention, a method for adjusting a fluid-vacuuming capability of a pump, the pump having a vacuuming capability for vacuuming fluid in a cap member disposed facing a fluid ejecting head for ejecting fluid, includes: acquiring specific-vacuuming-capability information, in which a vacuuming-capability measuring section acquires the specific-vacuuming-capability information that indicates a vacuuming capability specific to the pump; storing the specific-vacuuming-capability information in a specific-vacuuming-capability-information storage unit; and correcting the specific vacuuming capability, in which a specific-vacuuming-capability correcting section corrects the specific vacuuming capability of the pump according to the specific-vacuuming-capability information and correction information stored in the correction-information storage unit for correcting the specific vacuuming capability.

### BRIEF DESCRIPTION OF THE DRAWINGS

The invention will be described with reference to the accompanying drawings, wherein like numbers reference like elements.

FIG. 1 is a schematic perspective view of an ink jet recording apparatus, which is an embodiment of a fluid ejecting apparatus having a tube pump of the invention.

FIG. 2 is a schematic view of a head cleaning mechanism and the like, shown in FIG. 1.

FIG. 3 is a schematic view of the main structure of the tube pump.

FIG. 4 is a schematic block diagram of the ink jet recording apparatus shown in FIG. 1.

FIG. 5 is a table of pump-drive-correction data stored in a pump-drive-correction data storage unit.

FIG. 6 is a flow chart showing steps for correcting the ink vacuuming capability of the tube pump of the ink jet recording apparatus according to the first embodiment.

FIG. 7 is a schematic block diagram of the main structure of an ink jet recording apparatus according to a second embodiment of the invention.

FIG. 8 is a table of pump-drive-correction data according to the second embodiment.

FIG. 9 is a schematic block diagram of the main structure of an ink jet recording apparatus according to a third embodiment of the invention.

FIG. 10 is a schematic view of code-associated ink-vacuum-amount data stored in a code-associated ink-vacuum-amount-data storage unit according to the third embodiment.

FIG. 11 is a flow chart showing steps for measuring the ink-vacuum amount of the tube pump of the ink jet recording apparatus according to the third embodiment.

### DESCRIPTION OF EXEMPLARY EMBODIMENTS

Preferred embodiments of the invention will now be described in detail with reference to the attached drawings.

Because the embodiments to be described below are preferred examples of the invention, they include some technically desirable limitations. However, the invention is not limited thereto, unless otherwise stated in the following description.

### First Embodiment

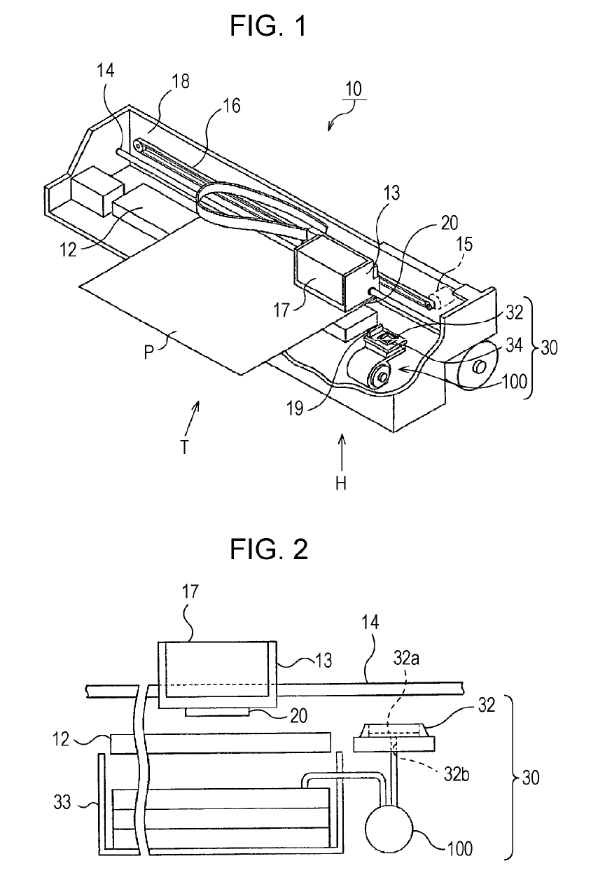

FIG. 1 is a schematic perspective view of an ink jet recording apparatus (hereinafter, a “recording apparatus”) 10, which is an embodiment of a fluid ejecting apparatus having a tube pump of the invention.

As shown in FIG. 1, the recording apparatus 10 includes a frame 18, on which a platen 12 is disposed. Paper P is fed over the platen 12 by a paper-feed mechanism (not shown).

The recording apparatus 10 also includes a carriage 13, which is supported in a manner capable of movement in the lengthwise direction of the platen 12 through a guide member 14 and is reciprocated by a carriage motor 15 through a timing belt 16.

The carriage 13 includes an ink jet recording head (hereinafter, a “recording head”) 20, which serves as a fluid ejecting head, on the bottom surface thereof. The recording head 20 ejects a fluid, for example, a liquid such as ink, onto the paper P.

More specifically, the recording head 20 includes nozzles for ejecting ink. Bending of a piezoelectric vibrator causes ink droplets to be ejected from the nozzles.

An ink cartridge 17 for containing ink is installed on the carriage 13 in a removable manner. Ink is supplied from the ink cartridge 17 to the recording head 20.

The piezoelectric vibrator is bent according to print data, while the carriage 13 is moved along the platen 12. This causes the recording head 20 to eject ink onto the paper P, whereby printing is performed.

The frame 18 (shown in FIG. 1) includes a printing region T, where the paper P is placed to be subjected to printing, and a home position H, which is a non-printing region, at one end.

The carriage 13 is movable between the printing region T and the home position H by moving along the platen 12.

As shown in FIG. 1, a head cleaning mechanism 30 is disposed at the home position H. The head cleaning mechanism 30 includes a cap holder 34 and a tube pump 100. The cap holder 34 is mounted to the frame 18 through a known lifting mechanism (not shown) so as to allow vertical movement thereof.

The head cleaning mechanism 30 also includes a cap 32, which serves as a cap member. When the upper end of the cap 32 is brought into contact with a nozzle plate of the recording head 20, the cap 32 can seal the nozzles of the recording head 20.

As shown in FIG. 1, the recording apparatus 10 further includes a blade 19. The blade 19 comes into contact with the nozzle plate of the recording head 20 and wipes off ink.

FIG. 2 is a schematic view of the head cleaning mechanism 30 and the like, shown in FIG. 1.

As shown in FIG. 2, the cap 32 includes a sheet sponge 32a disposed at the bottom thereof. When the cap 32 is in contact with the recording head 20, the sponge 32a faces the nozzles of the recording head 20 at a predetermined distance and absorbs ink ejected from the nozzles of the recording head 20.

As shown in FIG. 2, the cap 32 further includes a discharge port 32b penetrating the bottom surface thereof.

While the cap 32 seals the nozzles of the recording head 20, the tube pump 100 reduces the pressure in the cap 32 to create a negative pressure in the cap 32, and vacuums ink from the nozzles of the recording head 20. Then, the tube pump 100 discharges the ink into a waste ink tank 33 provided in the frame 18.

The tube pump 100 is an example of the pump having a vacuuming capability for vacuuming ink in the cap 32.

Although the first embodiment will be described taking a tube pump as an example, the invention is not limited thereto. Another pump, such as a piston pump, may also be used.

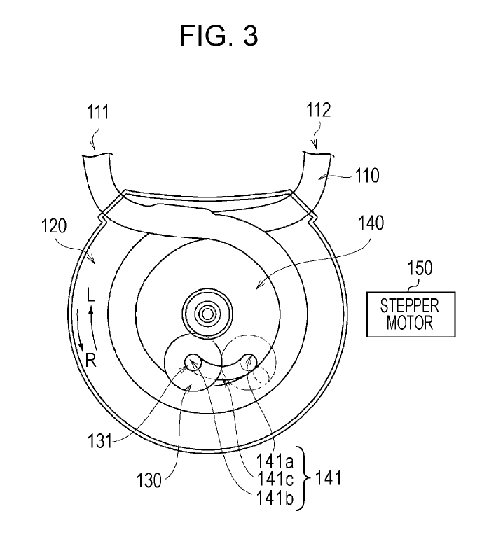

FIG. 3 is a schematic view of the main structure of the tube pump 100. As shown in FIG. 3, the tube pump 100 includes, for example, a tube 110, which serves as a tube member for vacuuming ink.

The tube 110 is continuously formed of a material such as rubber or resin, and is a single long component. One end of the tube 110 makes a cap-side opening 111 for vacuuming ink, and the other end of the tube 110 makes a waste-ink-tank-side opening 112 for discharging ink.

As shown in FIG. 3, the tube pump 100 also includes a pump frame 120 for allowing the tube 110 to be disposed therein in the form of a loop. More specifically, the tube 110 is disposed in the pump frame 120.

The tube 110 surrounds a pump wheel 140, which rotates along the tube 110. The pump wheel 140 is rotated in the directions shown by arrows L and R in FIG. 3 by, for example, a stepper motor 150, which serves as a motor member.

As shown in FIG. 3, the tube pump 100 also has, for example, a roller 130, which serves as a roller member disposed in contact with the tube 110. The roller 130 is rotatable about a roller axis 131.

Now, movement of the roller 130 will be described. The pump wheel 140 includes a vacuum portion 141a for allowing the roller 130 to be positioned in a direction pressing the tube 110, and a release portion 141b for allowing the roller 130 to be positioned in a direction away from the tube 110.

The pump wheel 140 also includes a connecting portion 141c connecting the vacuum portion 141a and the release portion 141b.

The vacuum portion 141a, the release portion 141b, and the connecting portion 141c make a roller axis groove 141 that penetrates the pump wheel 140.

The roller 130 shown in FIG. 3 is movable in the roller axis groove 141 through the roller axis 131.

Movement of the roller 130, when the roller 130 is positioned at the release portion 141b shown in FIG. 3, will be described.

When the roller 130 is positioned at the release portion 141b, the roller 130 does not press the tube 110. Therefore, even if the roller 130 is moved with the pump wheel 140 in the direction of the arrow R along the tube 110, a sufficient negative pressure is not created. Thus, ink is not vacuumed.

More specifically, because the roller axis 131 is positioned at an end, i.e., the release portion 141b, of the roller axis groove 141, even if the rotation of the pump wheel 140 brings the roller axis groove 141 in the direction of the arrow R, the roller axis 131 remains pressed against the end of the release portion 141b.

When the pump wheel 140 rotates reversely and brings the roller axis groove 141 in the direction of the arrow L, the roller axis 131 is released from the state of being pressed against the end of the release portion 141b.

The roller 130 is in contact with the tube 110. Therefore, even if the roller axis groove 141 is brought in the direction of the arrow L, the friction between the roller 130 and the tube 110 causes the roller 130 to remain at the same position.

Accordingly, movement of the roller axis groove 141 in the direction of the arrow L causes the roller 130 to relatively move through the connecting portion 141c to the vacuum portion 141a.

The roller axis 131 of the roller 130, after it arrives at the vacuum portion 141a, is pressed against the end of the vacuum portion 141a, and begins to move with the roller axis groove 141 in the direction of the arrow L.

At this time, the roller 130 positioned at the vacuum portion 141a presses the tube 110. This creates a sufficient negative pressure in the tube 110, causing ink to be guided from the cap-side opening 111 to the waste-ink-tank-side opening 112. As described above, ink is guided from the cap 32 to the waste ink tank 33.

In short, the roller 130 creates in the tube 110 a negative pressure for vacuuming ink, by pressing the tube 110 while moving along the tube 110.

After ink is vacuumed, the pump wheel 140 again rotates reversely, i.e., in the direction of the arrow R. This brings the roller axis groove 141 in the direction of the arrow R. The roller 130, however, remains at the same position because of the friction between the roller 130 and the tube 110, as described above, and becomes positioned at the release portion 141b, where the tube pump 100 is non-ink-vacuuming state.

The tube pump 100 switches between the ink-vacuuming state and the non-ink-vacuuming state by allowing the roller 130 to move between the vacuum portion 141a and the release portion 141b, utilizing the friction between the roller 130 and the tube 110.

When the tube pump 100 vacuums ink as described above, the stepper motor 150 causes the roller 130 to move so as to press the tube 110.

In other words, the stepper motor 150 drives the roller 130.

If tube pumps are made from the same (or uniform) components, the ink-vacuuming capabilities of the tube pumps must be the same. The amount of ink vacuumed by a tube pump can be known by counting the number of rotations of the roller along the tube, and by multiplying the result by the amount of ink vacuumed per rotation of the roller.

However, in reality, tube pumps have different vacuuming capabilities because of dimensional variation of the components constituting the tube pumps and assembly variation occurred in the manufacturing process.

Therefore, even if rollers operate in the same way as shown in FIG. 3, tube pumps vacuum different amounts of ink, leading to a problem in that head cleaning mechanisms of recording apparatuses have different capabilities.

In the first embodiment, the following structure is employed to prevent tube pumps from having different vacuuming capabilities.

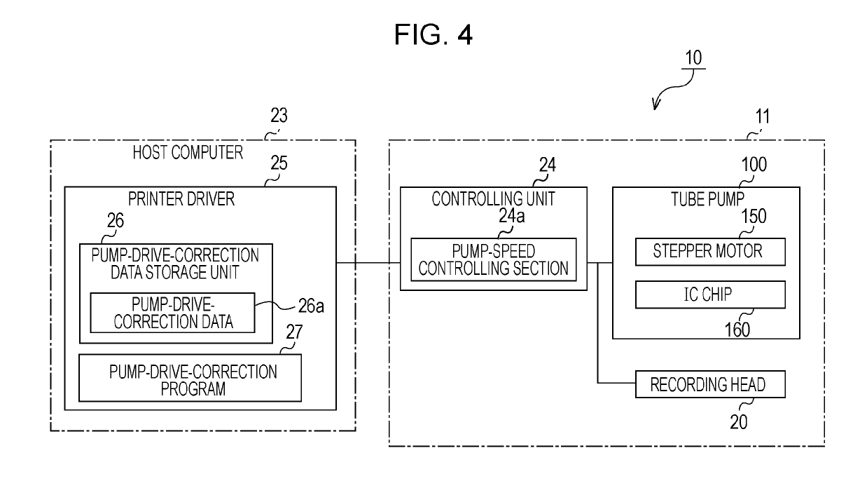

FIG. 4 is a schematic block diagram of the recording apparatus 10 shown in FIG. 1. As shown in FIG. 4, the recording apparatus 10 includes a recording apparatus main body 11 and a host computer 23. The recording apparatus main body 11 includes a controlling unit 24. The controlling unit 24 is connected to the tube pump 100, the recording head 20, and the like, to control them.

The tube pump 100 includes the stepper motor 150 and an IC chip 160, for example, which serves as a storage element.

The IC chip 160 stores ink-vacuuming capability data of the tube pump 100 in the form of code information. The code information will be described below.

The controlling unit 24 includes a pump-speed controlling section 24a (for example, a pump controlling program) for controlling the rotational speed of the roller 130 of the tube pump 100 along the tube 110.

The controlling unit 24 is connected to the host computer 23 via a local printer cable or a communication network.

The host computer 23 includes a printer driver 25. The printer driver 25 includes a pump-drive-correction data storage unit 26.

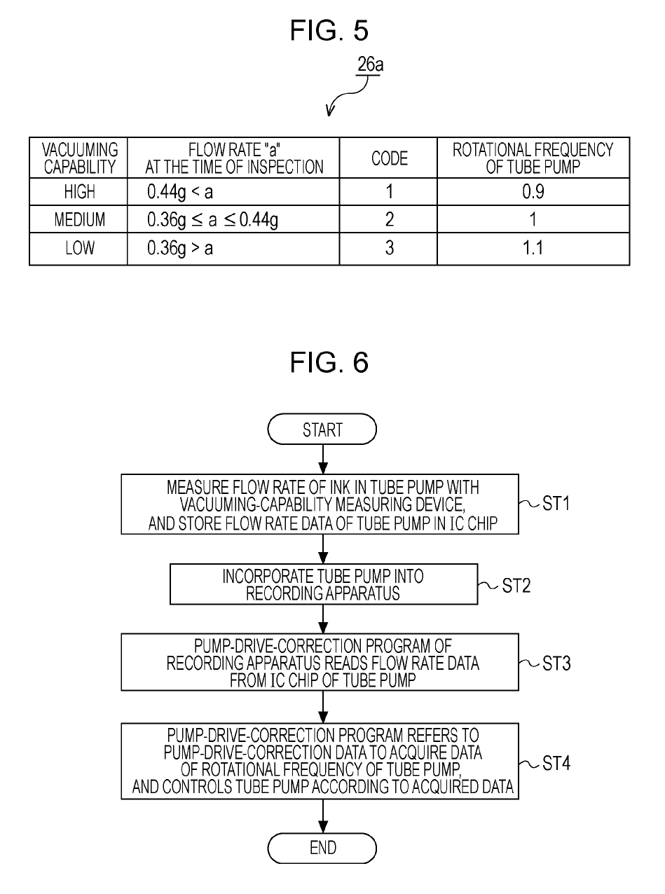

FIG. 5 is a table of pump-drive-correction data 26a stored in the pump-drive-correction data storage unit 26.

As shown in FIG. 5, in the pump-drive-correction data 26a, there are three types of ink-vacuuming capability of tube pumps, namely, high, medium, and low ink-vacuuming capability types.

Tube pumps are classified into these types according to the flow rate thereof measured at the time of inspection. As shown in FIG. 5, tube pumps with a flow rate higher than 0.44 g/s at the time of inspection are classified into the “high” ink-vacuuming capability type. The flow rate of tube pumps is measured by a vacuuming-capability measuring device (not shown), which is an example of the vacuuming-capability measuring section, to determine the ink-vacuuming capability of the tube pumps.

Data of the flow rate measured at the time of inspection, shown in FIG. 5, shows the ink-vacuuming capability of tube pumps measured by the vacuuming-capability measuring device in the form of the flow rate per second.

Tube pumps with a flow rate measured at the time of inspection in the range from 0.36 g/s to 0.44 g/s are classified into the “medium” ink-vacuuming capability type, and tube pumps with a flow rate measured at the time of inspection lower than 0.36 g/s are classified into the “low” ink-vacuuming capability type.

In the pump-drive-correction data 26a of FIG. 5, the “high”, “medium”, and “low” ink-vacuuming capability types of tube pumps correspond to a code 1, a code 2, and a code 3, respectively.

The pump-drive-correction data 26a includes correction values for driving of tube pumps, corresponding to the respective codes. In the first embodiment, the correction values are the rotational frequencies of tube pumps (the number of rotations of the roller along the tube, as shown in FIG. 3).

Where the rotational frequency of tube pumps of the “medium” ink-vacuuming capability type is 1, the rotational frequency of tube pumps of the “high” ink-vacuuming capability type is 0.9, and the rotational frequency of tube pumps of the “low” ink-vacuuming capability type is 1.1.

That is, if the vacuuming capability of the tube pump 100 is higher than the “medium” vacuuming capability, which is the normal vacuuming capability, the rotational frequency of the tube pump 100 is reduced so that the normal vacuuming capability is approached.

In contrast, if the vacuuming capability of the tube pump 100 is lower than the “medium” vacuuming capability, the rotational frequency of the tube pump 100 is increased so that the normal vacuuming capability is approached.

Such a reduction or increase in the rotational frequency of the tube pump 100 is performed by the pump-speed controlling section 24a of the controlling unit 24 (shown in FIG. 4) controlling the rotation of the stepper motor 150 of the tube pump 100.

The tube pump 100 is given any one of the codes 1 to 3 (shown in FIG. 5) according to the vacuuming capability thereof to indicate the specific ink-vacuuming capability, when the ink-vacuuming capability of the tube pump 100 is measured by the vacuuming-capability measuring device.

The code, such as the code 1, given to the tube pump 100 is stored in the IC chip 160 (shown in FIG. 4).

The code data (an example of the code information) indicating the vacuuming capability of the tube pump 100 is an example of the specific-vacuuming-capability information. The IC chip 160 is an example of the specific-vacuuming-capability-information storage unit. The data of the flow rate measured at the time of inspection (shown in FIG. 5) indicated by the code data is an example of the information about the flow rate of fluid in the tube pump 100 for a certain period of time.

The pump-drive-correction data storage unit 26 is an example of the correction-information storage unit. The data of the rotational frequency of the tube pump 100 is an example of the correction information.

Although the flow rate data as shown in FIG. 5 is utilized in the first embodiment, flow velocity data may also be utilized.

The recording apparatus 10 that includes the tube pump 100 having the code data indicating the ink vacuuming capability thereof corrects the ink vacuuming capability of the tube pump 100 as follows.

FIG. 6 is a flow chart showing steps for correcting the ink vacuuming capability of the tube pump 100 of the recording apparatus 10 according to the first embodiment.

In step ST1, in the manufacturing process of the recording apparatus 10, before the tube pump 100 is incorporated into the recording apparatus 10, the flow rate of ink in the tube pump 100 is measured with the vacuuming-capability measuring device to acquire flow rate data of the tube pump 100. The flow rate data is stored in the IC chip 160 (shown in FIG. 4) as code data. These are examples of acquiring specific-vacuuming-capability information and storing the specific-vacuuming-capability information.

Because the ink-vacuuming capabilities of tube pumps are accurately measured by the vacuuming-capability measuring device, data on variation (individual differences) in ink-vacuuming capability between the tube pumps can be accurately acquired.

In step ST2, the tube pump 100 is incorporated into the recording apparatus 10. Although the ink-vacuuming capability of the tube pump 100 is measured before the tube pump 100 is incorporated into the recording apparatus 10 in the first embodiment, it may be measured after the tube pump 100 is incorporated into the recording apparatus 10.

The tube pump 100 is now incorporated into the recording apparatus 10. From step ST3, the recording apparatus 10 performs printing on the paper P (shown in FIG. 1), and performs head cleaning, etc.

As shown in step ST3, when the recording apparatus 10 performs head cleaning, a pump-drive-correction program 27 in the printer driver 25 of the recording apparatus 10 is activated and acquires the code data (such as the code 1, 2, or 3), which is the flow rate data, from the IC chip 160 (shown in FIG. 4) of the tube pump 100.

In the first embodiment, because the IC chip 160 stores the code data of the tube pump 100, even if the tube pump 100 is replaced with a new tube pump, code data of the new tube pump can be acquired from the IC chip of the new tube pump.

That is, even if the tube pump 100 is replaced with a new tube pump, the recording apparatus 10 can always be provided with the most appropriate data.

Because the IC chip 160 stores simple code data, no complex structure for storing or acquiring the data is required. Thus, it becomes possible to locate necessary data at a low cost and using a simple structure.

In step ST4, the pump-drive-correction program 27 refers to the pump-drive-correction data 26a (shown in FIG. 5) to acquire data of the rotational frequency of the tube pump 100. Then, the pump-drive-correction program 27 controls the rotational frequency of the roller 130 relative to the tube 110 (shown in FIG. 3) according to the data of the rotational frequency of the tube pump 100, using the pump-speed controlling section 24a and the stepper motor 150. This is an example of the correcting the specific vacuuming capability.

More specifically, if the pump-drive-correction program 27 acquires the “code 1”, it determines that the tube pump 100 is of the “high” ink-vacuuming capability type. The pump-drive-correction program 27 then controls movement of the roller 130 according to the rotational frequency of the tube pump 100, which is 0.9.

The pump-drive-correction program 27 is an example of the specific-vacuuming-capability correcting section.

As described above, in the first embodiment, even if the ink-vacuuming capabilities of tube pumps incorporated into recording apparatuses vary, i.e., the tube pumps have individual differences, such a variation can be eliminated by correcting movement of the tube pumps, and ink-vacuuming capabilities can be made uniform. Accordingly, it becomes possible to provide a recording apparatus having a tube pump capable of vacuuming an adequate amount of ink.

### Second Embodiment

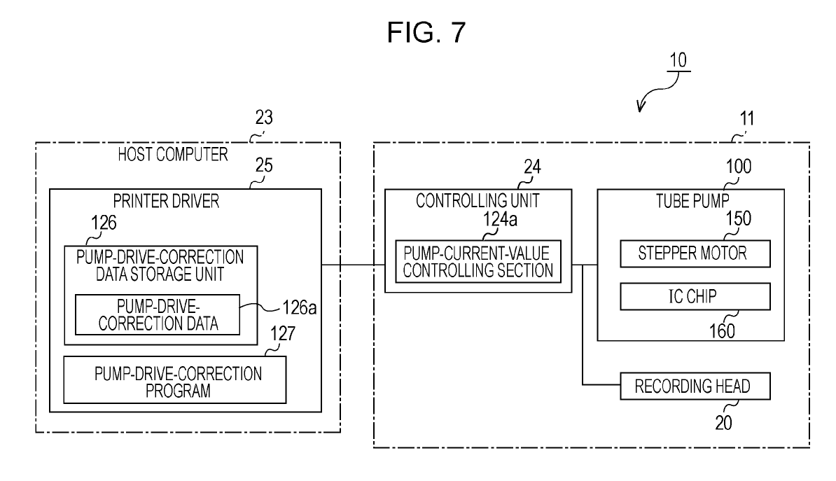

FIG. 7 is a schematic block diagram of the main structure of the recording apparatus 10 according to a second embodiment of the invention.

Because many of the structures according to the second embodiment are common to those according to the first embodiment, the common structures are designated by like reference numerals, and explanation therefor will be omitted. The difference will mainly be described below.

As shown in FIG. 7, in the second embodiment, unlike the first embodiment, correction of the ink-vacuuming capability of the tube pump 100 is controlled by a pump-current-value controlling section 124a (for example, a pump-current-value controlling program).

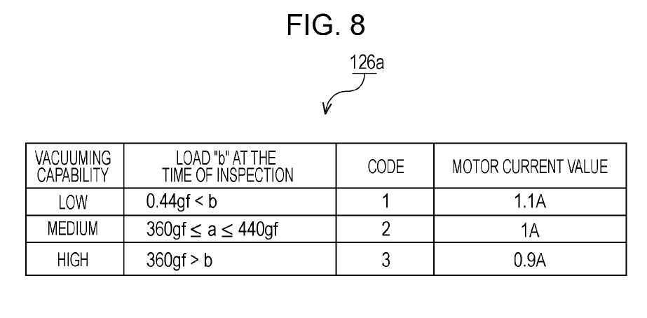

Therefore, pump-drive-correction data 126a (shown in FIG. 8) stored in a pump-drive-correction data storage unit 126 is also different from the pump-drive-correction data 26a of the first embodiment.

FIG. 8 is a table of the pump-drive-correction data 126a according to the second embodiment.

As shown in FIG. 8, in the pump-drive-correction data 126a, there are three types of vacuuming capability of tube pumps, which is the ink-vacuuming capability specific to the tube pumps, classified according to the load applied to the stepper motor 150, i.e., the maximum load applied to the stepper motor 150 while the roller 130 (shown in FIG. 3) makes one rotation along the tube 110.

Thus, as shown in FIG. 8, if the load is low, it is determined that the tube pump 100 is of the “high” ink-vacuuming capability type. In such a case, the motor current value is reduced to slow down the roller 130.

In contrast, if the load is high, it is determined that the tube pump 100 is of the “low” ink-vacuuming capability type. In such a case, the motor current value is increased to accelerate the roller 130.

The pump-drive-correction program 127 (shown in FIG. 7) instructs the pump-current-value controlling section 124a, according to the data shown in FIG. 8, to control the stepper motor 150 by controlling the current value of the stepper motor 150, and controls the movement of the roller 130.

The data of the load (shown in FIG. 8) acquired at the time of inspection is an example of the information about a load, and the motor current value data is an example of the correction information.

### Third Embodiment

In order to accurately determine the amount of ink vacuumed by a tube pump when there are tube pumps having different vacuuming capabilities, the third embodiment has the following structures. Because many of the structures according to the third embodiment are common to those according to the first and second embodiments, the common structures are designated by like reference numerals, and explanation therefor will be omitted. The difference will mainly be described below.

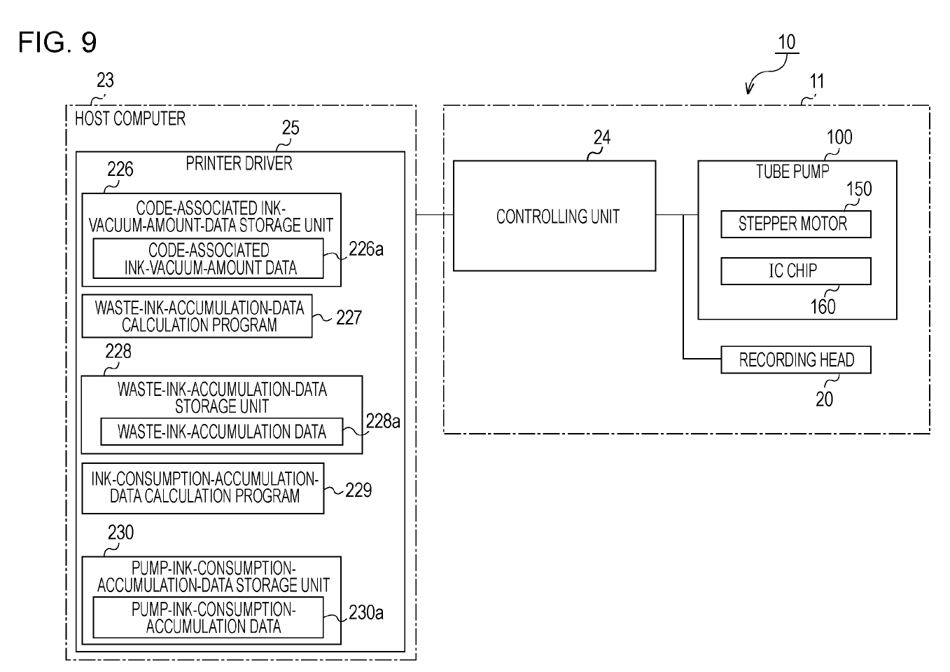

FIG. 9 is a schematic block diagram of the main structure of the recording apparatus 10 according to the third embodiment of the invention. The IC chip 160 shown in FIG. 9 stores ink-vacuuming capability data of the tube pump 100 in the form of code information. The code information will be described below.

The controlling unit 24 is connected to the host computer 23 via a local printer cable or a communication network.

The host computer 23 includes the printer driver 25. The printer driver 25 includes a code-associated ink-vacuum-amount-data storage unit 226.

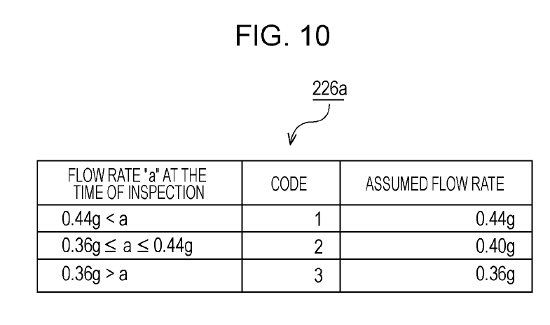

FIG. 10 is a table of code-associated ink-vacuum-amount data 226a stored in the code-associated ink-vacuum-amount-data storage unit 226.

As shown in FIG. 10, in the code-associated ink-vacuum-amount data 226a, there are three types of ink-vacuuming capability of tube pumps, which are denoted by a code 1, a code 2, and a code 3.

Tube pumps are classified into these types according to the flow rate thereof measured at the time of inspection. As shown in FIG. 10, tube pumps with a flow rate higher than 0.44 g/s at the time of inspection are classified into the “code 1”. The flow rate of tube pumps is measured by a vacuuming-capability measuring device (not shown), which is an example of the vacuuming-capability measuring section, to determine the ink-vacuuming capability of the tube pumps.

Data of the flow rate measured at the time of inspection, shown in FIG. 10, shows the ink-vacuuming capability of tube pumps measured by the vacuuming-capability measuring device in the form of the flow rate per second.

Tube pumps with a flow rate measured at the time of inspection in the range from 0.36 g/s to 0.44 g/s are classified into the “code 2”, and tube pumps with a flow rate measured at the time of inspection lower than 0.36 g/s are classified into the “code 3”.

In the code-associated ink-vacuum-amount data 226a shown in FIG. 10, the “code 1”, the “code 2”, and the “code 3” correspond to assumed flow rates “0.44 g”, “0.40 g”, and “0.36 g”, respectively.

That is, if the flow rate measured at the time of inspection is higher than 0.44 g, the amount of ink vacuumed by the tube pump 100, while the roller 130 makes one rotation along the tube 110, is assumed to be “0.44 g”.

Accordingly, the amount of ink vacuumed by the tube pump 100 of the code 1 can be calculated by multiplying “0.44 g” by the rotational frequency of the roller 130.

Similarly, the amount of ink vacuumed by the tube pump 100 of the code 2, while the roller 130 makes one rotation along the tube 110, is assumed to be “0.40 g”, and the amount of ink vacuumed by the tube pump 100 of the code 3 is assumed to be “0.36 g”.

The tube pump 100 is given any one of the codes 1 to 3 according to the vacuuming capability thereof to indicate the specific ink-vacuuming capability, when the ink-vacuuming capability of the tube pump 100 is measured by the vacuuming-capability measuring device.

The code, such as the code 1, given to the tube pump 100 is stored in the IC chip 160 (shown in FIG. 9).

The code data (an example of the code information) indicating the vacuuming capability of the tube pump 100 is an example of the specific-vacuuming-capability information. The IC chip 160 is an example of the specific-vacuuming-capability-information storage unit. The data of the flow rate measured at the time of inspection (shown in FIG. 10) indicated by the code data is an example of the information about the flow rate of fluid in the tube pump 100 for a certain period of time.

The code-associated ink-vacuum-amount-data storage unit 226 is an example of the specific-vacuuming-capability-information storage unit. The data of the assumed flow rate shown in FIG. 10 is an example of the specific-vacuuming-capability information.

Although the flow rate data as shown in FIG. 10 is utilized in the third embodiment, the flow velocity data may also be utilized.

The recording apparatus 10 that includes the tube pump 100 having the code data indicating the ink vacuuming capability thereof acquires data of the amount of ink vacuumed by the tube pump 100 as follows.

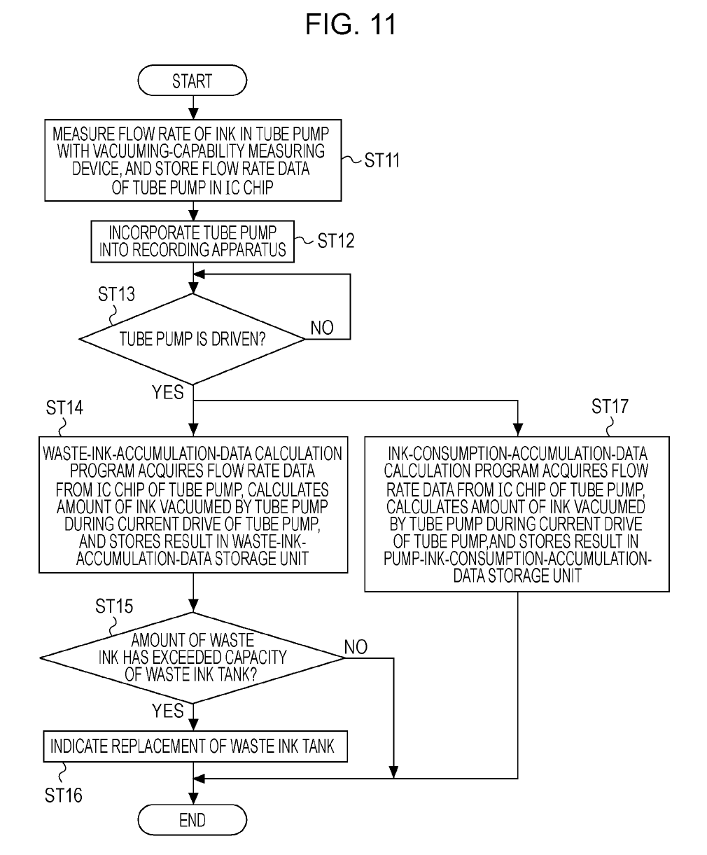

FIG. 11 is a flow chart showing steps for measuring the amount of ink vacuumed by the tube pump 100 of the recording apparatus 10 according to the third embodiment.

In step ST11, in the manufacturing process of the recording apparatus 10, before the tube pump 100 is incorporated into the recording apparatus 10, the flow rate of ink in the tube pump 100 is measured with the vacuuming-capability measuring device to acquire flow rate data of the tube pump 100. The flow rate data is stored in the IC chip 160 (shown in FIG. 9) as code data. These are examples of acquiring specific-vacuuming-capability information and storing the specific-vacuuming-capability information.

Because the ink-vacuuming capabilities of tube pumps are accurately measured by the vacuuming-capability measuring device, data on variation (individual differences) in ink-vacuuming capability between the tube pumps can be accurately acquired.

In step ST12, the tube pump 100 is incorporated into the recording apparatus 10. Although the ink-vacuuming capability of the tube pump 100 is measured before the tube pump 100 is incorporated into the recording apparatus 10 in the third embodiment, it may be measured after the tube pump 100 is incorporated into the recording apparatus 10.

The tube pump 100 is now incorporated into the recording apparatus 10. From step ST13, the recording apparatus 10 measures the amount of ink vacuumed by the tube pump 100.

When the recording apparatus 10 measures the amount of ink vacuumed by the tube pump 100, in step ST13, whether the tube pump 100 is driven is determined.

In step ST14, a waste-ink-accumulation-data calculation program 227 in the printer driver 25 of the recording apparatus 10 is activated, and acquires the code data (such as the code 1, 2, or 3), which is the flow rate data, from the IC chip 160 of the tube pump 100 (shown in FIG. 9).

In the third embodiment, because the IC chip 160 stores the code data of the tube pump 100, even if the tube pump 100 is replaced with a new tube pump, code data of the new tube pump can be acquired from the IC chip of the new tube pump.

That is, even if the tube pump 100 is replaced with a new tube pump, the recording apparatus 10 is provided with the code data of the new tube pump. This means that the recording apparatus 10 can always be provided with the most appropriate data.

Because the IC chip 160 stores simple code data, no complex structure for storing or acquiring the data is required. Thus, it becomes possible to locate necessary data at a low cost and using a simple structure.

In step ST14, the waste-ink-accumulation-data calculation program 227 refers to the assumed flow rate (such as 0.44 g) corresponding to the code data (such as code 1) in the code-associated ink-vacuum-amount data 226a (shown in FIG. 10), to specify the assumed flow rate (such as 0.44 g).

The waste-ink-accumulation-data calculation program 227 also acquires data of the rotational frequency of the tube pump 100, and calculates the amount of ink vacuumed by the tube pump 100 during the current drive of the tube pump 100, by multiplying the rotational frequency of the tube pump 100 by the assumed flow rate.

The calculated amount of ink vacuumed by the tube pump 100 is stored in the waste-ink-accumulation-data storage unit 228 (shown in FIG. 9) as waste-ink-accumulation data 228a.

That is, the amount of ink vacuumed by the tube pump 100 during the current drive is added to the waste-ink-accumulation data 228a accumulated thus far to acquire new waste-ink-accumulation data (an example of generating specific-vacuuming-capability information).

As described above, in the third embodiment, even if the ink-vacuuming capabilities of the tube pumps incorporated into recording apparatuses vary, i.e., the tube pumps have individual differences, such individual differences can be accurately determined. Accordingly, the amount of ink vacuumed by the tube pump 100 can be accurately determined.

The waste-ink-accumulation-data calculation program 227 is an example of a specific-vacuum-result-information generation section, and the waste-ink-accumulation-data storage unit 228 is an example of an information storage unit for storing information about the amount of waste liquid in the waste ink tank and information about the specific vacuum result.

In step ST15, whether the amount of waste ink stored in the waste ink tank 33 (shown in FIG. 2) has exceeded the capacity of the waste ink tank 33 is determined.

That is, whether the amount of waste ink, which is indicated by the waste-ink-accumulation data 228a (shown in FIG. 9), has exceeded the capacity of the waste ink tank 33 is determined.

Because the waste-ink-accumulation data 228a is accurate, the determination of whether the amount of waste ink has exceeded the capacity of the waste ink tank 33 can be done accurately. This eliminates the necessity of replacing the waste ink tank 33 that still has a room for waste ink with a new one, which has occurred with a conventional apparatus. This enables the waste ink tank 33 to be fully used.

In step ST15, if it is determined that the amount of waste ink has exceeded the capacity of the waste ink tank 33, the process proceeds to step ST16, where replacement of the waste ink tank 33 is indicated to a user.

In step ST17 of FIG. 11, an ink-consumption-accumulation-data calculation program 229 (shown in FIG. 9) is activated, and calculates the amount of ink vacuumed (consumed) by the tube pump 100 during the current drive, according to the code data (such as code 1) stored in the IC chip 160 of the tube pump 100 (shown in FIG. 9), the assumed flow rate data (shown in FIG. 10), and the rotational frequency of the tube pump 100.

The result is stored in a pump-ink-consumption-accumulation-data storage unit 230 (shown in FIG. 9) as pump-ink-consumption-accumulation data 230a.

That is, the amount of ink vacuumed by the tube pump 100 during the current drive is added to the pump-ink-consumption-accumulation data 230a accumulated thus far to acquire new pump-ink-consumption-accumulation data.

By performing above-described steps, the recording apparatus 10 can accurately manage the amount of ink consumed by the tube pump 100.

The pump-ink-consumption-accumulation data 230a is an example of pump-vacuum-amount-accumulation information.

The invention may be applied to accurately manage the amount of ink, not only in the waste ink tank 33, but also in the ink cartridge 17.

The invention is not limited to the above-described embodiments. In the above-described embodiments, the fluid ejecting apparatus is embodied as an ink jet recording apparatus. However, the fluid ejecting apparatus may also be embodied as a fluid ejecting apparatus for ejecting or discharging a fluid other than ink (including liquid, liquid with particles of a functional material dispersed therein, a flowable material such as gel, and a solid material that can be flowed and ejected as fluid).

The fluid ejecting apparatus may also be embodied as, for example, a liquid ejecting apparatus for ejecting a liquid containing an electrode material, a color material, or the like dispersed or dissolved therein used for manufacturing liquid crystal displays, electro-luminescent (EL) displays, or plane emission displays. Alternatively, the fluid ejecting apparatus may be embodied as a liquid ejecting apparatus for ejecting a living organic material used for manufacturing biochips. Yet alternatively, the fluid ejecting apparatus may be embodied as a liquid ejecting apparatus for ejecting liquid used as a fine pipette that serves as a sample. Other examples of the fluid ejecting apparatus to which the invention can be applied include: a liquid ejecting apparatus for ejecting a lubricant against precision machines such as clocks and cameras with pinpoint precision; a liquid ejecting apparatus for ejecting a transparent resin such as an ultraviolet curable resin against a substrate to manufacture hemispherical micro lenses (optical lenses); a liquid ejecting apparatus for ejecting acid or alkaline etchant for performing etching on a substrate or the like; a fluid ejecting apparatus for ejecting a predetermined amount of gel, such as medicine, health food extracts, flavoring, or gelatin, into capsules to enclose the gel; and a toner jet recording apparatus for ejecting a solid material, for example, a powder material such as toner. The invention may be applied to the above-described fluid ejecting apparatuses.

The entire disclosure of Japanese Patent Application Nos: 2007-055183, field Mar. 6, 2007 and 2007-055184, field Mar. 6, 2007 and 2007-338533, field Dec. 28, 2007 are expressly incorporated by reference herein.

What is claimed is:

1. A tube pump for a fluid ejecting apparatus, the tube pump vacuuming fluid through a cap member from a fluid ejecting head for ejecting fluid, the tube pump comprising:
a specific-vacuuming-capability-information storage unit for storing specific-vacuuming-capability information that indicates a vacuuming capability specific to the tube pump.

2. The tube pump according to claim 1,
wherein the specific-vacuuming-capability information includes information about a flow rate or flow velocity of fluid in the tube pump for a certain period of time.

3. The tube pump according to claim 1,
wherein the specific-vacuuming-capability information includes information about a load applied to a motor for driving the tube pump when the motor drives the tube pump.

4. The tube pump according to claim 1,
wherein the specific-vacuuming-capability information includes code information.

5. The tube pump according to claim 1,
wherein the specific-vacuuming-capability-information storage unit is disposed in the tube pump.

6. A fluid ejecting apparatus comprising:
a fluid ejecting head for ejecting fluid; and
the tube pump according to claim 1.

7. The fluid ejecting apparatus according to claim 6, further comprising:
a correction-information storage unit for storing correction information used to correct the specific vacuuming capability of the tube pump according to the specific-vacuuming-capability information; and
a specific-vacuuming-capability correcting section for correcting the specific vacuuming capability of the tube pump according to the correction information.

8. The fluid ejecting apparatus according to claim 6, wherein the fluid ejecting apparatus specifies a vacuum flow rate of the tube pump according to the specific-vacuuming-capability information, and calculates the amount of fluid vacuumed by the tube pump using the specified vacuum flow rate.

9. A method for adjusting a fluid-vacuuming capability of a pump, the pump having a vacuuming capability for vacuuming fluid in a cap member disposed facing a fluid ejecting head for ejecting fluid, the method comprising:
acquiring specific-vacuuming-capability information, in which a vacuuming-capability measuring section acquires the specific-vacuuming-capability information that indicates a vacuuming capability specific to the pump;
storing the specific-vacuuming-capability information in a specific-vacuuming-capability-information storage unit; and
correcting the specific vacuuming capability, in which a specific-vacuuming-capability correcting section corrects the specific vacuuming capability of the pump according to the specific-vacuuming-capability information and correction information stored in the correction-information storage unit for correcting the specific vacuuming capability.
